(19) United States
(12) Patent Application Publication
(10) Pub. No.: US 2002/0149563 A1
(43) Pub. Date: Oct. 17, 2002

(54) Joystick control with icon selection function

(75) Inventor: Larry Don Swofford, Georgetown, TX (US)

Correspondence Address: Andrew J. Dillon, BRACEWELL & PATTERSON, LLP, Lakewood on the Park, Suite 350, 7600B North Capital of Texas Highway, Austin, TX, 78731, US

(73) Assignee: International Business Machines Corporation, Armonk, NY (US)

(21) Appl. No.: 09/833,409

(22) Filed: Apr. 12, 2001

(51) Int. Cl. G09G 5/08

(52) U.S. Cl. 345/161

(57) ABSTRACT

A joystick control which generates control signals adapted to relocate a displayed moveable cursor in an X and Y-axis within a computer display which includes at least one selectable icon in response to a movement to a joystick lever in those axes. Location of the moveable cursor into a position overlying a selectable icon allows the selection of that icon in response to movement of the joystick lever in the Z-axis. Additionally, selection of at least one selectable icon results in the display of a simulated keyboard. Thereafter, location of the moveable cursor into a position overlying a particular key permits selection of that particular key in response to movement of the joystick lever in the Z-axis. In this manner, applications may be selected and data entered without utilizing a keyboard or mouse button, greatly enhancing the usability of a computer system by those users who lack fine motor control skills.

### BACKGROUND OF THE INVENTION

1. Technical Field

The present invention relates in general to improved computer user interface devices and in particular to user interface devices which obviate the requirement for keyboard or mouse button manipulation. Still more particularly, the present invention relates to an improved computer user interface for use by mobility impaired users.

2. Description of the Related Art

The so-called “personal computer” has become quite ubiquitous in the modem world. The ease and efficiency with which data and information may be manipulated and obtained utilizing a personal computer are well known. While such devices are a great asset to individuals and households, the utilization of such devices by those people who are mobility or sight impaired can be quite difficult.

Numerous attempts have been made to provide an audible user interface for personal computers so that such devices may be utilized by persons who are vision impaired. Such devices typically utilize stereo effects or various sound effects to provide the information which is typically displayed visually to a non-handicapped person.

Another class of users for whom utilization of a personal computer is difficult are those individuals who are mobility impaired. Such individuals may be confined to a wheelchair or may lack the fine motor control skills to utilize a traditional keyboard mouse or stylus for user input.

One example of a device for use by quadriplegics to operate a computer is illustrated in U.S. Pat. No. 4,486,630. That patent discloses a headset for supporting electrical contacts which are operated by movement of the user's jaw and/or eyebrows.

While such devices provide for the utilization of personal computers by individuals who are substantially mobility impaired, a large number of users exist who are capable of gross motor movement or control but lack the fine motor control skills to accurately operate a keyboard, stylus, mouse or other user input device. These individuals are deprived of the utilization of a personal computer and it should thus be apparent that a need exists for a method or system whereby such individuals can simply and easily interact with a modem personal computer.

### SUMMARY OF THE INVENTION

It is therefore one object of the present invention to provide an improved computer user interface device.

It is another object of the present invention to provide an improved user interface device which obviates the requirement for keyboard or mouse button manipulation.

It is yet another object of the present invention to provide an improved computer user interface for use by mobility impaired users who lack fine motor control skills.

The forgoing objects are achieved as is now described. A joystick control is provided which generates control signals adapted to relocate a displayed moveable cursor in an X and Y-axis within a computer display which includes at least one selectable icon in response to a movement to a joystick lever in those axes. Location of the moveable cursor into a position overlying a selectable icon allows the selection of that icon in response to movement of the joystick lever in the Z-axis. Additionally, selection of at least one selectable icon results in the display of a simulated keyboard. Thereafter, location of the moveable cursor into a position overlying a particular key permits selection of that particular key in response to movement of the joystick lever in the Z-axis. In this manner, applications may be selected and data entered without utilizing a keyboard or mouse button, greatly enhancing the usability of a computer system by those users who lack fine motor control skills.

### BRIEF DESCRIPTION OF THE DRAWINGS

The novel features believed characteristics of the invention are set forth in the appended claims. The present invention itself, however, as well as a preferred mode of use, further objectives, and advantages thereof, will best be understood by reference to the following detailed description of a preferred embodiment when read in conjunction with the accompanying drawings, wherein:

FIG. 1 is a pictorial representation of a computer system and the joystick of the present invention;

FIG. 2 is a high level block diagram of the computer system of FIG. 1;

FIG. 3 is a schematic cutaway top view of the joystick of the present invention;

FIG. 4 is a schematic cutaway side view of the joystick of the present invention;

FIG. 5 is a pictorial representation of a computer screen illustrating utilization of the joystick of the present invention;

FIG. 6 is a pictorial representation of a computer screen illustrating utilization of the joystick of the present invention to input text; and

FIG. 7 is a high level logic flowchart illustrating the process by which the joystick of the present invention may be utilized with a computer system.

### DESCRIPTION OF THE PREFERRED EMBODIMENT

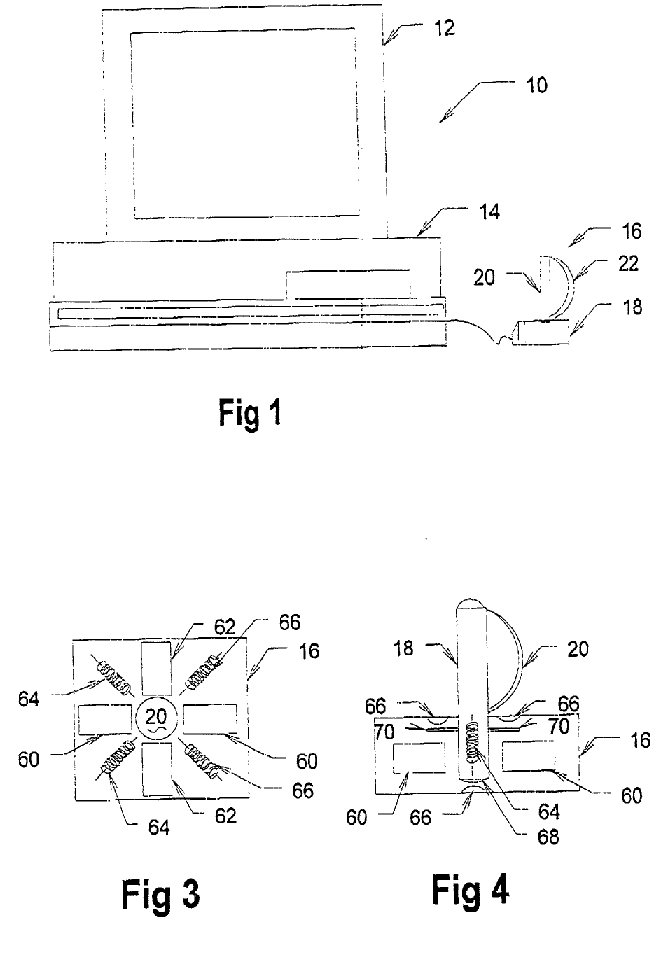

With reference now to the figures and in particular with reference to FIG. 1, there is depicted a computer system 10. As those skilled in the art will appreciate, computer system 10 typically includes a video display 12 and a processor subsystem 14. Those having ordinary skill in this art will appreciate that video display 12 may comprise a cathode-ray tube, liquid crystal display (LCD), or any other suitable visual display device. Coupled to processor subsystem 14 is joystick 16. As illustrated, joystick 16 includes a base pedestal 18, a joystick lever 20 and an elongate strap 22 which is affixed to joystick lever 20 at each end thereof.

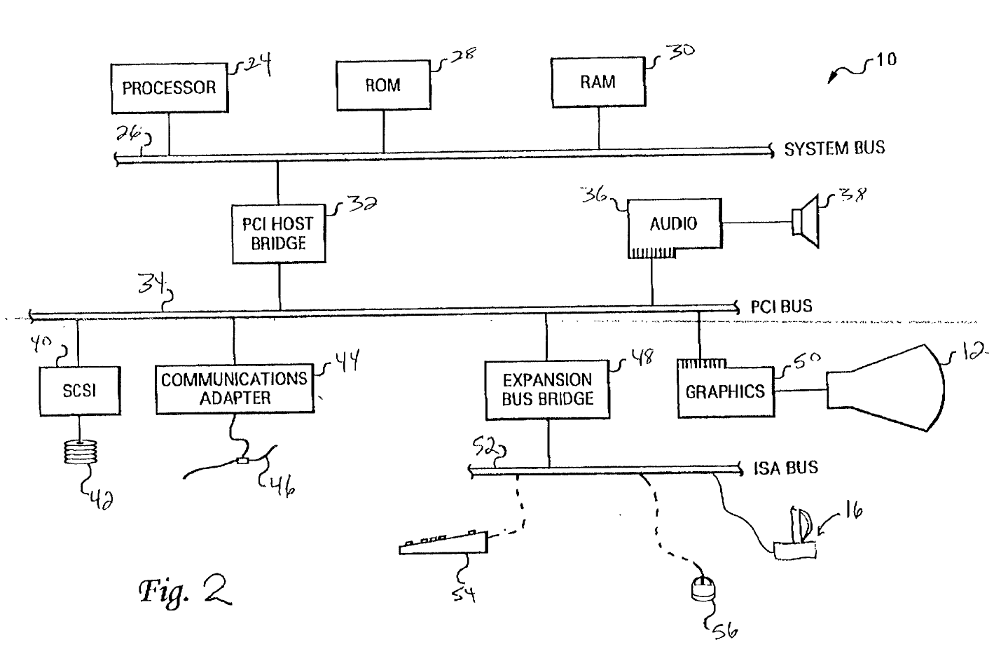

Referring now to FIG. 2, there is depicted a high level block diagram of the computer system 10 of FIG. 1. As depicted, computer system 10 includes a processor 24 which is coupled to system bus 26. Also coupled to system bus 26 are read-only-memory (ROM) 28 and random access memory (RAM) 30 which provide storage for data and instructions which may be accessed by processor 24. Various instructions in the form of a computer program product may be stored within ROM 28 or RAM 30, for example, and executed by processor 24 to implement the method and system of the present invention System bus 26 is typically coupled to a PCI bus 34 via a Peripherical Component Interconnect (PCI) host bridge 32. PCI host bridge 32 provides both a low latency path through which processor 24 may directly access various PCI devices mapped to bus memory and/or I/O address basis and a high bandwidth path through which PCI devices may directly access random access memory 30.

Those PCI devices which are typically connected to a PCI local bus include a Small Computer System Interface (SCSI) controller 40 which provides connections for multiple peripherals such as a high speed SCSI disk drive 42 and a communication adaptor 44 which may provide network communications between processor 24 and a remote network 46 (not shown).

Additionally, in order to present audio and video data to a user, computer system 10 typically includes a PCI-compatible audio controller 36 and graphic controller 50 which directly drive speakers 38 and video display 12 respectively.

PCI bus 34 is further coupled to an expansion bus, such as ISA bus 52, via an expansion bus bridge 48. Coupled to ISA bus 52 can be a number of conventional input devices, such as a keyboard 54, a mouse 56 and a joystick 16, such as that disclosed within the present application.

Referring now to FIG. 3, there is depicted a schematic cutaway top view of joystick 16 of the present invention. As illustrated, joystick lever 20 is mounted vertically within pedestal 18 and maintained in a vertical posture utilizing a multiple springs 64. Of course, those skilled in the art will appreciate that other techniques may be utilized to position joystick lever 20; however, all such devices have in common the physical biasing of joystick lever 20 into a vertical position.

Also depicted within FIG. 3 are joystick lever movement detection devices 60 and 62. As illustrated, a pair of movement detection devices 60 are disposed in a first axis and a second pair 62 are disposed in a second axis. In this manner, movement of joystick lever 20 in either an X or Y-axis can be detected and utilized to generate a control signal capable of relocating a moveable cursor within computer display 12.

Those having ordinary skill in the art will appreciate that X-axis movement detection devices 60 and Y-axis movement detection devices 62 may comprise simple potentiometers or optical devices which measure the movement of joystick lever 20 in both axes.

Referring now to FIG. 4, there is depicted a schematic cutaway side view of joystick 16 of the present invention. As illustrated, joystick lever 20 also includes a spring 64 which may be utilized to bias the position of joystick lever 20 to a neutral position with respect to the Z-axis. As illustrated within FIG. 4, a plurality of electrical contacts 66 are disposed directly beneath joystick lever 20 and surrounding the aperture within pedestal 18 though which joystick lever 20 is mounted. In this manner, as those having ordinary skill in the art will appreciate, the movement of joystick lever 20 in a Z-axis will result in a contact between an electrical contact 66 and contact point 68 or between electrical contacts 66 and contact levers 70. Thus, it should be apparent to those having ordinary skill in the art upon reference thereto, that in addition to detecting movement of joystick lever 20 in an X-axis or Y-axis direction, the movement of joystick lever 20 in a vertical or Z-axis direction can also be detected by this arrangement. Of course, this Z-axis detection may be utilized to select and/or deselect an icon or application by movement in opposite directions in the Z-axis or by a continuous toggling of a single switch point.

Those having ordinary skill in the art will appreciate that other detection technique may be utilized including, for example, optical or magnetic detection devices.

In accordance with an important feature of the present invention, it may be seen that joystick 16 includes a strap 22 which is elongate and flexible and attached to joystick lever 20 at each end thereof. In this manner, a user having limited fine motor control skills may place his or her hand within the aperture formed between elongate strap 22 and joystick lever 20 in order to raise or lower joystick lever 20 in the Z-axis without requiring the fine motor control skills necessary to grasp and raise or lower joystick lever 20.

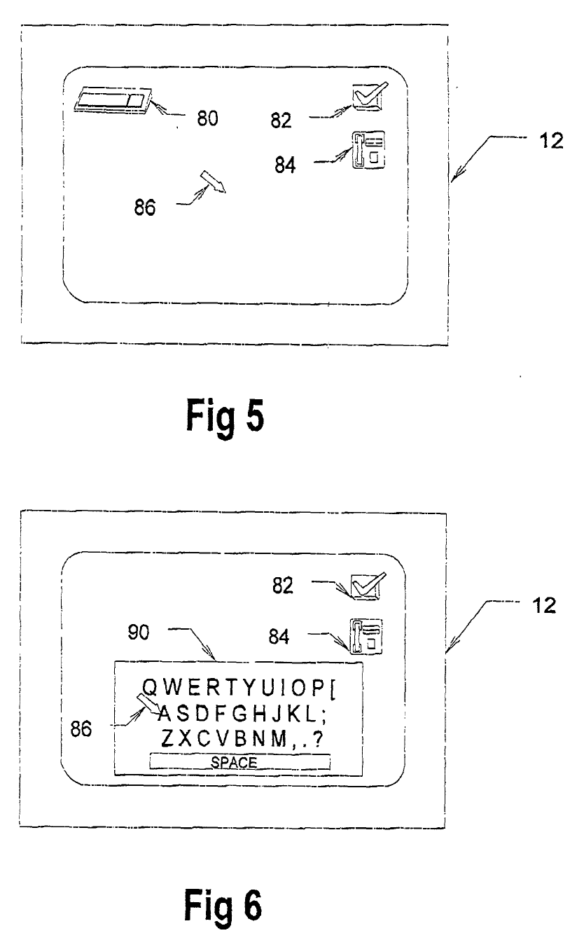

Referring now to FIG. 5, there is depicted a pictorial representation of a computer display screen 12 which illustrates utilization of the joystick of the present invention. As illustrated, computer display 12 may include one or more selectable icons such as icons 80, 82, and 84. Of course, each icon may represent a graphic indication of an application or device, or individually selectable menu items from a graphical user interface. In a manner well known to those having ordinary skill in the art, a moveable cursor 86 is also provided. Thereafter, in a conventional manner, moveable cursor 86 may be relocated within computer display 12 to a position which overlies one of the selectable icons depicted therein. Next, as described above with respect to FIG. 4, movement of the joystick lever in the Z-axis can result in the selection or deselection of a particular icon, enabling a mobility impaired user to select an application within a graphic user interface without requiring the fine motor skills control typically required for keyboard or mouse button manipulation.

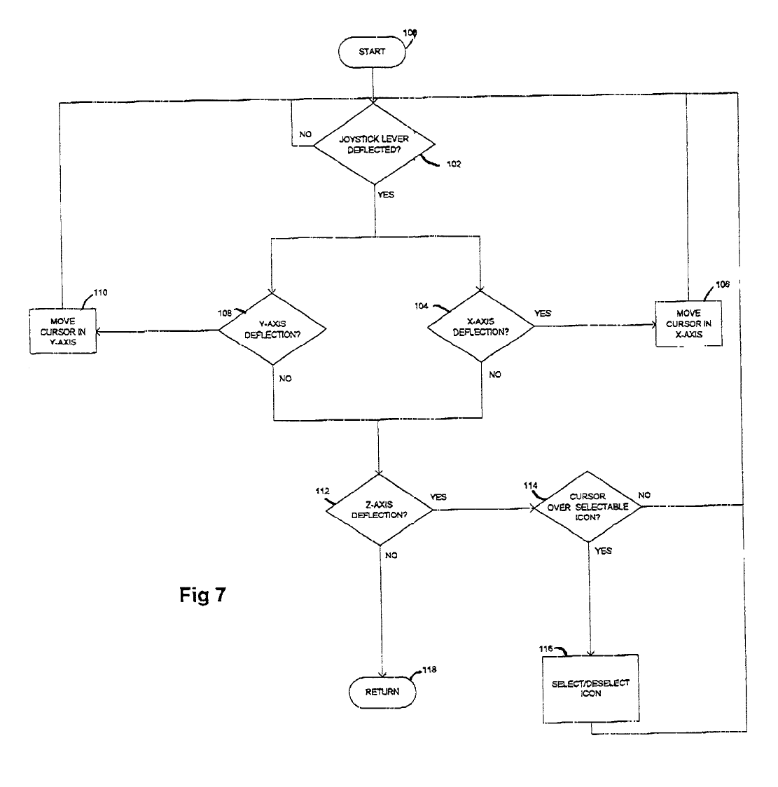

As depicted within FIG. 5, icon 80 graphically depicts a keyboard. Selection of icon 80 utilizing the afore mentioned technique will result in the temporary display of a simulated computer keyboard 90 within computer display 12 in the manner depicted within FIG. 6. As illustrated, FIG. 6 depicts the utilization of the joystick of the present invention in a manner which permits the inputting of text without requiring the fine motor control skills necessary to manipulate a keyboard. As depicted, movement of moveable cursor 86 to a position overlying one of the letters within simulated keyboard 90 can permit that letter and subsequent letters to be selected by gross movement or movements of joystick lever 20 in the Z-axis, greatly simplifying the entry of data for those mobility impaired users utilizing the system of the present invention.

Finally, with reference to FIG. 7, there is depicted a high level flowchart which illustrates the method and computer program product by which the joystick of the present invention may be employed within a computer system. As depicted, this process begins at block 100 and thereafter passes to block 102. Block 102 illustrates a determination of whether or not the joystick lever has been deflected and if not, the process merely iterates until such time as deflection of the joystick lever has been detected.

After detecting deflection of the joystick lever, as illustrated in block 102, the process passes to blocks 104 and 108. Block 104 illustrates a determination of whether or not any of the deflection is within the X-axis and if so, the process passes to block 106. Block 106 illustrates the movement of the cursor in the X-axis and the iterative return to block 102 to once again determine whether or not the joystick lever remains deflected.

Block 108 illustrates a determination of whether or not any of the joystick lever deflection is in the Y-axis and if so, in the manner described above, the process passes to block 110 which illustrates the movement of the moveable cursor in the Y-axis. Thereafter, the process returns in an iterative fashion to block 102 to determine whether or not the joystick lever remains deflected.

Still referring to blocks 104 and 108, in the event the deflection of the joystick lever does not occur in the X or Y-axis, the process passes to block 112. Block 112 illustrates a determination of whether or not the joystick lever has been deflected in the Z-axis and if so, the process passes to block 114. Block 114 illustrates a determination of whether or not the moveable cursor overlies a selectable icon at that point and if not, the process merely returns to block 102 in an iterative fashion for processing as described above. However, in the event the cursor does overlie a selectable icon, the process passes to block 116. Block 116 illustrates the selection or deselection of that icon prior to returning to block 102, in an iterative fashion. While the illustrated embodiment discloses a select/deselect toggle approach those with skill in this art will appreciate that alternate selection/deselection techniques may by utilized. For example, movement in the Z-axis in a first direction may signify selection while movement in the Z-axis in a second direction may signify deselection. Similarly, selection or deselection may be signified by multiple movements in either direction in the Z-axis.

Referring again to block 112, in the event the deflection does not occur in the Z-axis, the process passes to 118 and returns, to await subsequent deflection of the joystick lever.

Upon reference to the foregoing, those skilled in the art will appreciate that the inventor herein has described a system whereby those individuals who lack fine motor control skills but who can nevertheless grossly manipulate a joystick controller may select or deselect particular applications within a graphic user interface and enter text without requiring the fine motor control skills necessary to utilize a keyboard or manipulate the buttons of a state-of-the-art mouse.

While the invention has been particularly shown and described with reference to a preferred embodiment, it will be understood by those skilled in the art that various changes in form and detail may be made therein without departing from the spirit and scope of the invention.

What is claimed is:

1. A joystick control for use with a computer system having a display with a moveable cursor and one or more selectable icons displayed therein, said joystick control comprising:
a moveable joystick lever;
a first means associated with said moveable joystick lever for developing a first control signal effective to relocate said moveable cursor along an X-axis in response to movement of said moveable joystick lever in said X-axis;
a second means associated with said moveable joystick lever for developing a second control signal effective to relocate said moveable cursor along a Y-axis in response to movement of said moveable joystick lever in said Y-axis; and
a third means associated with said moveable joystick lever for selecting an icon underlying said moveable cursor in response to movement of said moveable joystick lever in a first direction along a Z-axis.

2. The joystick control according to claim 1, further including a fourth means associated with said moveable joystick lever for deselecting an icon underlying said moveable cursor in response to movement of said moveable joystick lever in a second direction along said Z-axis.

3. The joystick control according to claim 1, further including a grip aperture associated with said moveable joystick lever sized appropriately to receive a human hand.

4. The joystick control according to claim 3, wherein said grip aperture comprises a flexible elongate strap affixed at each end thereof to said moveable joystick lever.

5. The joystick control according to claim 1, wherein said first means comprises a potentiometer affixed to said moveable joystick lever and adapted to vary the impedance thereof in response to movement of said moveable joystick lever in an X-axis.

6. The joystick control according to claim 1, wherein said second means comprises a potentiometer affixed to said moveable joystick lever and adapted to vary the impedance thereof in response to movement of said moveable joystick lever in an Y-axis.

7. The joystick control according to claim 1, wherein said third means comprises a momentary contact switch.

8. The joystick control according to claim 1, wherein said first means comprises an optical detector for optically detecting movement of said moveable joystick lever in said X-axis.

9. The joystick control according to claim 1, said second means comprises an optical detector for optically detecting movement of said moveable joystick lever in said Y-axis.

10. A computer system, said computer system comprising:
a processor;
a video output display coupled to said processor for displaying one or more selectable icons and a moveable cursor;
a joystick control coupled to said processor, said joystick control comprising:
a moveable joystick lever;
a first means associated with said moveable joystick lever for developing a first control signal effective to relocate said moveable cursor along an X-axis in response to movement of said moveable joystick lever in said X-axis;
a second means associated with said moveable joystick lever for developing a second control signal effective to relocate said moveable cursor along a Y-axis in response to movement of said moveable joystick lever in said Y-axis; and
a third means associated with said moveable joystick lever for selecting an icon underlying said moveable cursor in response to movement of said moveable joystick lever in a first direction along a Z-axis.

11. A computer system according to claim 10, further including a fourth means associated with said moveable joystick lever for deselecting an icon underlying said moveable cursor in response to movement of said moveable joystick lever in a second direction along said Z-axis.

12. A method for permitting selection of one or more selectable icons in a computer system having a joystick lever and a display with a moveable cursor and one or more selectable icons displayed therein, said method comprising the steps of: moving said moveable cursor along an X-axis in response to movement of
said joystick lever in said X-axis;
moving said moveable cursor along a Y-axis in response to movement of said joystick lever in said Y-axis; and, selecting an icon underlying said moveable cursor in response to movement of said joystick lever in a first direction along a Z-axis.

13. The method for permitting selection of one or more selectable icons according to claim 12 further including the step of:
deselecting an icon underlying said moveable cursor in response to movement of said joystick lever in a second direction along said Z-axis.

14. A computer program product for permitting selection of one or more selectable icons in a computer system having a joystick lever and a display with a moveable cursor and one or more selectable icons displayed therein, said computer program product comprising:
a computer readable media;
instruction means, embodied within said computer readable media for moving said moveable cursor along an X-axis in response to movement of said joystick lever in said X-axis;
instruction means embodied within said computer readable media for moving said moveable cursor along a Y-axis in response to movement of said joystick lever in said Y-axis; and
instruction means embodied within said computer readable media for selecting an icon underlying said moveable cursor in response to movement of said joystick lever in a first direction along a Z-axis.

15. The computer program product according to claim 14 further including:
instruction means embodied within said computer readable media for deselecting an icon underlying said moveable cursor in response to movement of said joystick lever in a second direction along said Z-axis.
